(19) United States
(12) Patent Application Publication
(10) Pub. No.: US 2026/0356028 A1
(43) Pub. Date: Nov. 12, 2026

(54) METHOD FOR MANUFACTURING AN ACOUSTIC COMPONENT BY STAMPING

(71) Applicant: SAFRAN, PARIS (FR)

(72) Inventors: Hugues Laurent ALGLAVE, MOISSY-CRAMAYEL (FR); Nicolas Pierre LANFANT, MOISSY-CRAMAYEL (FR); Patrick DUNLEAVY, MOISSY-CRAMAYEL (FR)

(21) Appl. No.: 19/133,305

(22) PCT Filed: Nov. 24, 2023
(86) PCT No.: PCT/FR2023/051851

§ 371 Date: May 28, 2025

(30) Foreign Application Priority Data
Nov. 28, 2022 (FR) 2212400

(51) Int. Cl. B29C 51/08; B29C 51/20; B29C 51/30; B29C 51/42; B29L 22/00

(52) U.S. Cl. CPC B29C 51/082; B29C 51/20; B29C 51/30; B29C 51/421; B29C 51/428; B29L 2022/00

(57) ABSTRACT

A method for manufacturing an acoustic component, includes positioning a thermoplastic material preform between first and second parts of a stamping tool which parts are heated to a first temperature that is above the glass transition or melting temperature of the preform, shaping the thermoplastic material preform by bringing together the first and second parts of the stamping tool, which parts are maintained at the first temperature during the shaping of the preform, compacting the shaped preform in the stamping tool at a compaction pressure value and at the first temperature, cooling the molding surfaces of the first and second parts of the stamping tool to a second temperature of less than or equal to the solidification temperature of the thermoplastic material.

### TECHNICAL FIELD

The present invention relates to the general field of acoustic attenuation structures or panels. It relates more particularly to acoustic attenuation structures used to reduce noise produced in aircraft engines such as in gas turbines or their exhausts.

### PRIOR ART

Acoustic attenuation structures typically consist of an acoustic surface plate or skin permeable to the acoustic waves that are to be attenuated and a reflective solid plate or skin called a “closing plate”, a cellular body, such as a honeycomb or a porous structure, being disposed between these two walls. In a well-known manner, such panels form Helmholtz-type resonators that allow to attenuate acoustic waves in a certain frequency range. Acoustic attenuation structures of this type are described in particular in documents U.S. Pat. No. 5,912,442 and GB 2 314 526.

These acoustic attenuation structures are limited to simple cell shapes such as those of the alveoli of a conventional NIDA® type structure. With this technology, the processed frequency is of the order of a quarter of the inverse of the cavity height. To process low frequencies, very high cavities are therefore required which, in the case of propulsion systems, considerably increase their drag. Furthermore, the acoustic performance obtained is limited to the absorption of a very narrow frequency range.

One solution to increase the acoustic attenuation frequency range is to superimpose two cell bodies with different cell shapes and dimensions. This solution has the disadvantage of significantly increasing the size and drag of the acoustic attenuation structure.

Another known solution consists in placing open truncated cones in alveoli as described in documents EP 0 738 865 and FR 3 082 987. Although this solution allows to reduce the size of the acoustic attenuation structure, the mass of the structure remains significant and, consequently, penalizing for uses in aircraft where control of the overall mass is always sought.

Document WO 2021/198610 discloses the manufacture of a complex acoustic multi-element panel comprising a plurality of acoustic elements having a cone shape or the like by injection of a thermoplastic material. However, the conventional injection method, that is to say injection of a thermoplastic material into a closed temperature-controlled mold, is not suitable for the manufacture of acoustic elements of very low thickness, typically having a wall thickness of less than 1 mm and more precisely comprised between 0.1 mm and 0.6 mm, as is the case in particular when the thermoplastic material is of the polyetherimide (PEI) or polyetheretherketone (PEEK) type.

### DISCLOSURE OF THE INVENTION

The purpose of the present invention is therefore to propose a manufacturing solution for acoustic attenuation structures made of thermoplastic material which do not have the aforementioned disadvantages.

According to the invention, this object is achieved by means of a method for manufacturing an acoustic component comprising a plurality of hollow complex acoustic elements each having a shape that gradually narrows between a base and a top, the hollow complex acoustic elements being connected to each other by one or more adjacent edges, the method comprising:
positioning a thermoplastic material preform between first and second parts of a stamping tool, the first part having a molding surface including a plurality of cavities having a shape corresponding to the shape of the hollow complex acoustic elements of the acoustic component to be manufactured, the second part having a molding surface comprising a plurality of protuberances having a shape complementary to the cavities, the first and second parts of the stamping tool being heated to a first temperature that is above the glass transition or melting temperature of the preform,
shaping the thermoplastic material preform by bringing together the first and second parts of the stamping tool at a determined rate so as to gradually compress the preform between the molding surfaces of said first and second parts until reaching a closed position of the stamping tool, a pressure exerted between first and second parts of the stamping tool being progressively increased up to a compaction pressure value, the first and second parts of the stamping tool being maintained at the first temperature during the shaping of the preform,
compacting the shaped preform in the stamping tool in the closed position, the compacting being carried out at the compaction pressure value and over a determined compaction duration, the first and second parts of the stamping tool being maintained at the first temperature during the compaction of the preform,
cooling the molding surfaces of the first and second parts of the stamping tool to a second temperature of less than or equal to the solidification temperature of the thermoplastic material,
demolding the acoustic component comprising a plurality of hollow complex acoustic elements,
   method in which the shaping and compaction of the thermoplastic material preform are carried out over a total duration less than a reference duration corresponding to a fraction of the duration of degradation of the thermoplastic material of the preform at the first temperature.

The method of the invention thus implements specific operating conditions which allow to control the manufacture of the targeted acoustic component. Indeed, by maintaining the molding surfaces of the stamping tool at a temperature that is above the glass transition or melting temperature of the preform while gradually increasing the pressure between the first and second parts of the tool during the shaping of the preform, the filling of the cavities of the molding surface of the first part of the stamping tool with the thermoplastic material is precisely controlled. This progressive shaping at a temperature that is above the glass transition or melting temperature of the thermoplastic material of the preform allows to obtain a homogeneous distribution of the thermoplastic material on the molding surfaces.

The shaping of the preform is further followed by a compacting step to complete the closing of the stamping tool. The compacting step is carried out with the molding surfaces maintained at a temperature that is above the glass transition or melting temperature of the thermoplastic material of the preform, which ensures complete and homogeneous filling of the cavities of the molding surface with the thermoplastic material in the molten state, in particular when the space between the molding surfaces is very small.

The method of the invention thus allows to obtain, in an economical, reliable and repeatable manner, acoustic components equipped with complex shaped acoustic elements with a very low wall thickness typically less than 1 mm and more particularly comprised between 0.1 mm and 0.6 mm. The acoustic component thus obtained allows the manufacture of thinner and therefore lighter acoustic attenuation structures while respecting the required specifications in terms of size, mechanical performance and mass.

Moreover, the total duration of execution of the shaping and compacting steps is controlled so as not to exceed a threshold beyond which the thermoplastic material could be degraded, which allows to subject the thermoplastic material to high temperatures which are necessary for controlling the manufacture of the acoustic component without deteriorating the mechanical and physicochemical properties of the material.

According to a first particular aspect of the method of the invention, the reference duration corresponds to 80% of the degradation duration of the thermoplastic material of the preform at the first temperature.

According to a second particular aspect of the method of the invention, the thermoplastic material preform is preheated before being shaped, the preform being preheated to a third temperature of less than the softening temperature of the thermoplastic material, the preheating of the preform being carried out by heating panels or by radiation by maintaining the preform between the first and second parts of the stamping tool for a determined duration before the shaping of said preform. This preheating step is optional. When it is implemented, the preform retains its mechanical strength because it is preheated to a temperature of less than the softening temperature of the thermoplastic material. It is therefore easy to handle and position in the stamping tool.

According to a third particular aspect of the method of the invention, during the cooling of the molding surfaces of the first and second parts of the stamping tool, the pressure is gradually decreased from the compaction pressure value to atmospheric pressure, the decrease in pressure is controlled to reach atmospheric pressure when the molding surfaces of the first and second parts of the stamping tool have reached the solidification temperature of the thermoplastic material. The final shaping of the acoustic component is thus perfectly preserved.

According to a fourth particular aspect of the method of the invention, the thermoplastic material preform has a plurality of excess thickness portions present at determined locations on the film and spaced from each other by connecting portions having a thickness less than the thickness of the excess thickness portions, said locations corresponding to the locations of the cavities of the molding surface of the first part of the stamping tool. The excess thickness portions constitute a surplus of material which, once stretched or flowed into the molding cavities during the shaping of the acoustic component, will allow to form hollow complex acoustic elements connected together by connecting portions.

According to a fifth particular aspect of the method of the invention, the surface and thickness of each excess thickness portion is defined as a function of a projected surface and a thickness of each hollow complex acoustic element. It is thus possible to control the final thickness of the wall of the hollow complex acoustic elements, in particular so as to obtain a constant thickness over the entire acoustic component.

According to a sixth particular aspect of the method of the invention, each excess thickness portion extends between the connecting portions and an opening or cavity present in the center of the excess thickness portion. This facilitates the production of hollow complex acoustic elements. The opening or cavity can form a hole, which allows to directly form, by stamping, hollow complex acoustic elements with an opening at their top.

The invention also relates to a method for manufacturing an acoustic attenuation structure comprising the following steps:
producing an acoustic component according to the method for manufacturing an acoustic component of the invention,
producing a complex acoustic multi-element panel comprising the acoustic component and a plurality of partitions forming acoustic cavities, each complex acoustic element of the acoustic component being housed in an acoustic cavity so as to form an acoustic cell,
assembling a face of the complex acoustic multi-element panel with an assembly face of an acoustic skin.

The hollow complex acoustic elements of the acoustic component can be advantageously combined with partitions, which allows to lower the acoustic frequencies to be treated. It is thus possible to produce acoustic attenuation structures capable of attenuating lower frequency sound waves while having a reduced footprint.

According to a particular aspect of the method for manufacturing an acoustic attenuation structure, the acoustic attenuation structure further comprises a closing skin covering the horizontal face of the complex acoustic multi-element panel opposite the horizontal face covered by the acoustic skin, the method comprising assembling the workpiece joining the complex acoustic multi-element panel and the plurality of partitions with the closing skin.

### BRIEF DESCRIPTION OF THE DRAWINGS

FIG. 1 is a schematic sectional view of a thermoforming tool showing a step of manufacturing an acoustic component according to one embodiment of the invention,

FIG. 2 is a schematic sectional view of a thermoforming tool showing another step of manufacturing an acoustic component according to one embodiment of the invention,

FIG. 3 is a schematic sectional view of a thermoforming tool showing another step of manufacturing an acoustic component according to one embodiment of the invention,

FIG. 4 is a schematic sectional view of a thermoforming tool showing another step of manufacturing an acoustic component according to one embodiment of the invention,

FIG. 5 is a schematic perspective view of a thermoplastic material film used to manufacture an acoustic component according to one embodiment of the invention,

FIG. 6 is a schematic perspective view of a thermoplastic material film used to manufacture an acoustic component according to another embodiment of the invention,

FIG. 7 is an enlarged detail view of a portion of the thermoplastic material film of FIG. 6,

FIG. 8 is an exploded schematic perspective view of an acoustic attenuation structure according to one embodiment of the invention,

FIG. 9 is a schematic sectional view of the sound attenuating structure of FIG. 1 once assembled.

FIG. 10 is a graph showing the evolution of the temperature, pressure and position parameters of the stamping tool during the steps of the method of the invention.

### DESCRIPTION OF THE EMBODIMENTS

The invention applies to the manufacture of acoustic components comprising a plurality of hollow complex acoustic elements each having a shape gradually narrowing between a base and a top with an inlet orifice at the base and an outlet orifice at the top. The shape of the hollow complex acoustic elements can be any, the only condition being that the shape is demoldable. The hollow complex acoustic elements can have, for example, a conical or pyramidal shape.

The thermoplastic material used to manufacture the acoustic component of the invention is a high performance thermoplastic resin preferably selected from grades of polyaryletherketone (PAEK) such as polyetheretherketone (PEEK) and polyetherketoneketone (PEKK), polyetherimides (PEI), polyethersulfone (PES or PESU) and polyphenylene sulfide (PPS). The thermoplastic material may be filled or unfilled.

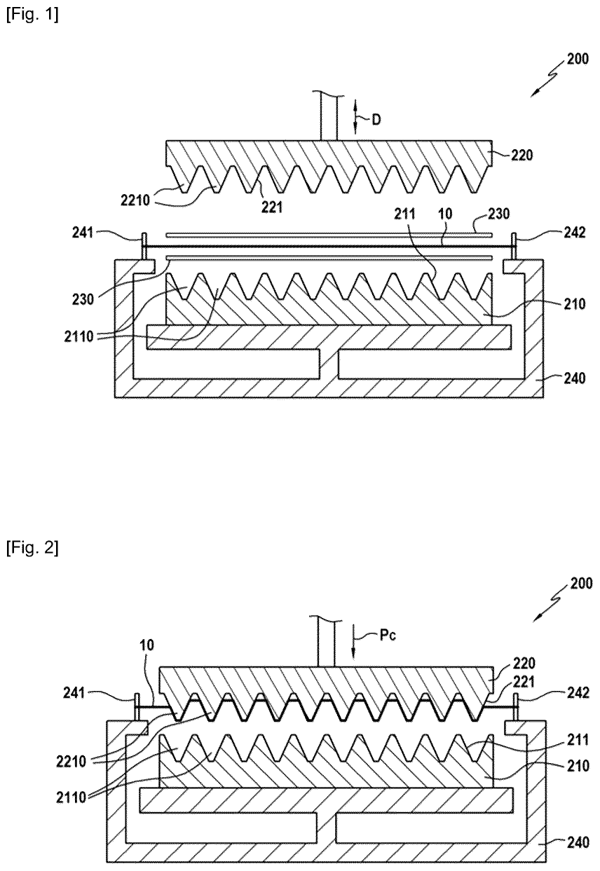

FIGS. 1 to 4 illustrate a method for manufacturing an acoustic component in accordance with one embodiment of the invention.

FIG. 1 illustrates a stamping tool 200 comprising a first part or mold 210, a second part or counter-mold 220 and a frame 240 supporting the mold 210. In the example described here the second part 220 of the stamping tool is movable in a double direction D while the first part 210 is immobilized on the frame 240. In an alternative embodiment, the first part can be movable relative to the second. In another alternative embodiment, the first and second parts are each movable.

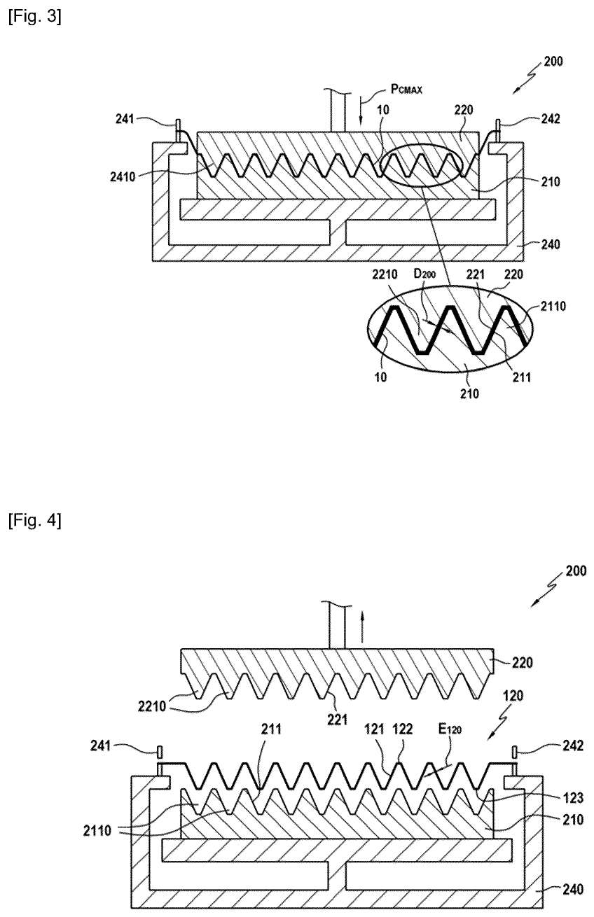

The stamping tool 200 is provided with actuating means (not shown in FIGS. 1 to 4) for moving at least the second part 220 or the first part 210 in the double direction D between an open position (FIG. 1) and a closed position (FIG. 3). The stamping tool is further associated with a press (not shown in FIGS. 1 to 4) for applying a compaction pressure between the first and second parts 210 and 220 of the tool as explained in detail below.

The frame 240 is provided with side clamps 241 and 242 for holding a thermoplastic preform 10 during the steps of forming an acoustic component. The thermoplastic preform can also be placed on the tool by an automaton or manually. It can also be supplied by a conveyor system.

The first part 210 of the stamping tool 200 comprises a molding surface 211 including cavities 2110 intended to cooperate with protrusions 2210 of a molding surface 221 of the second part 220 of the stamping tool 200 for forming the acoustic component from the thermoplastic preform 10. The cavities 2110 of the molding surface 211 of the first part 210 have a shape corresponding to the shape of the hollow complex acoustic elements of the acoustic component to be manufactured, the protrusions 2210 of the second part 220 having a shape complementary to the cavities 2110. In the example described here, the stamping tool 200 further comprises heating panels 230 for preheating the preform 10.

The method begins with the preheating by the heating panels 230 of the thermoplastic preform 10 to a temperature below the softening temperature of the thermoplastic material. According to an alternative, the preheating of the thermoplastic preform 10 can be carried out by holding the preform between the first and second parts 210 and 220 of the stamping tool 200 for a determined duration before shaping said preform. In this case, the first and second parts 210 and 220 are heated to a determined temperature allowing to heat the preform by radiation to a temperature below the softening temperature of the thermoplastic material.

This first step is optional in the method of the invention. Indeed, preheating is not mandatory because it is possible to directly position the preform at room temperature in the stamping tool. In the case where a preheating phase is implemented as in the example described here, the preform is preheated to a temperature below the softening temperature of the thermoplastic material, which ensures that the preform retains sufficient rigidity to facilitate its positioning or holding in the stamping tool, the mold being preheated to a temperature close to that chosen for the preform.

By way of non-limiting example:
for PEI or PESU grades, the preheating temperature limit is set at 200 °C
for PAEK grades, the preheating temperature limit is set at 300 °C
for PPS grades, the preheating temperature limit is set at 250 °C

The stamping method of the prior art requires preheating the preform to a temperature that is above the softening temperature of the thermoplastic matrix. Consequently, positioning the preform in the softened state in the stamping tool requires a specific protocol capable of rapidly heating then transporting a preform in the softened state from a heating furnace to the stamping tool. These operations are costly (dedicated furnace, soft preform transport frame, temperature control and automation of operations) and often complex to implement correctly. This process is also unsuitable for materials without reinforcement or filler because it is the presence of the reinforcement that ensures that the softened preform does not deform excessively during the transport operation from the preheating furnace to the stamping unit.

The method of the invention allows to avoid all the difficulties and limitations of prior art stamping since the preheating operation outside the stamping tool becomes optional and if it is implemented, it is done at a temperature of less than the softening temperature of the thermoplastic material, thereby eliminating any difficulty in transporting and positioning the preform. One of the advantages of the method of the invention is in particular that it applies indiscriminately to filled and unfilled thermoplastic materials.

The thermoplastic material preform 10 is then shaped. The first and second parts 210 and 220 of the stamping tool 200 or at least their respective molding surfaces 211 and 221 are first heated to a temperature that is above the glass transition or melting temperature of the thermoplastic material of the preform 10. More specifically, in the case of an amorphous thermoplastic material, the preform is heated to a temperature T_{SUP} that is above the glass transition temperature of the material, whereas, in the case of a semi-crystalline thermoplastic material, the preform is heated to a temperature that is above the melting temperature of the material.

For this purpose, the first and second parts 210 and 220 of the stamping tool 200 are equipped with rapid heating means such as a heating system by pulsed air, by induction or any other heating system capable of reaching heating rates ranging from the order of 30 °C/minute to 100 °C/minute.

By way of non-limiting example:
for PEI or PESU grades, the temperature T_{SUP} is comprised between 220 °C and 400 °C
for PAEK grades, the temperature T_{SUP} is comprised between 330 °C and 410 °C
for PPS grades, the temperature T_{SUP} is comprised between 220 °C and 400 °C

Once the molding surfaces 211 and 221 respectively of the first and second parts 210 and 220 of the stamping tool 200 have reached the temperature T_{SUP}, the second part 220 is moved towards the first part 210 as illustrated in FIG. 2 and until the protrusions 2210 of the second part 220 cooperate completely with the cavities 2110 of the first part as shown in FIG. 3 which corresponds to the closing position of the stamping tool 200. The thermoplastic material preform 10 is shaped locally in each of the cavities 2110. During this shaping step, the molding surfaces 211 and 221 of the first and second parts 210 and 220 of the stamping tool 200 are maintained at the temperature T_{SUP} that is above the glass transition or melting temperature of the thermoplastic material. The shaping of the preform 10 is carried out over a determined period D_{MEF}.

The first and second parts 210 and 220 of the stamping tool 200 are brought together at a controlled rate so as to gradually compress the preform between the molding surfaces of the first and second parts. Controlling the rate of bringing the parts 210 and 220 together also ensures a shear level on the preform that is lower than the limit shear of the thermoplastic material. The limit shear level of a thermoplastic material is generally indicated in the manufacturer's data but can be determined by testing if necessary. As a non-limiting example, provided that the performance of the chosen press is adapted to the dimensions of the workpiece (in terms of closing force), the rate of bringing together allowing a compression/closing of the mold can be chosen so as to allow the mold to close over a duration comprised between a few seconds and a few minutes.

A pressure P_{C} exerted between the first and second parts 210 and 220 of the stamping tool is gradually increased up to a compaction pressure value P_{COMP}.

By maintaining the molding surfaces of the stamping tool at a temperature that is above the glass transition or melting temperature of the preform while gradually increasing the pressure between the first and second parts of the tool during shaping of the preform, the filling of the cavities in the molding surface of the first part of the stamping tool with the thermoplastic material is precisely controlled.

This progressive shaping at a temperature that is above the glass transition or melting temperature of the thermoplastic material of the preform allows to obtain a homogeneous distribution of the thermoplastic material on the molding surfaces. With the stamping method of the prior art in which the stamping tool is maintained at a temperature close to the solidification temperature of the thermoplastic material, the setting time of the material is too short and the compaction pressure too high to be able to control the shaping and obtain homogeneous workpieces of good quality.

In accordance with the invention, the shaping step is followed by a step of compacting the shaped preform in the stamping tool. The compaction consists in maintaining the preform in the stamping tool for a determined duration D_{COMP} in the closed position (FIG. 3) while applying the compaction pressure P_{COMP} and maintaining the molding surfaces 211 and 221 of the first and second parts 210 and 220 of the stamping tool 200 at the temperature T_{SUP} that is above the glass transition or melting temperature of the thermoplastic material. The compaction pressure P_{COMP} is preferably greater than or equal to 100 bars.

The compacting step is carried out with the molding surfaces maintained at a temperature that is above the glass transition or melting temperature of the thermoplastic material of the preform, which ensures complete and homogeneous filling of the cavities of the molding surface with the thermoplastic material in the molten state, in particular when the space between the molding surfaces is very small.

In the closed position of the stamping tool 200 shown in FIG. 3, the molding surfaces 211 and 221 respectively of the first and second parts 210 and 220 are held facing each other at a very small distance D₂₀₀ corresponding to the wall thickness E₁₂₀ of the acoustic component 120 to be produced from the preform 10 (FIG. 4). The final wall thickness E120 is fixed at the end of the compacting step.

After the compacting step, the molding surfaces 211 and 221 respectively of the first and second parts 210 and 220 are cooled to a temperature of less than or equal to the solidification temperature of the thermoplastic material allowing to set said material in the shape of an acoustic component 120 to be manufactured. When cooling the molding surfaces of the first and second parts of the stamping tool, the pressure is gradually decreased from the compaction pressure value P_{COMP} to atmospheric pressure, the decrease in pressure is controlled to reach atmospheric pressure when the molding surfaces of the first and second parts of the stamping tool have reached the solidification temperature of the thermoplastic material.

The cooling of the molding surfaces 211 and 221 respectively of the first and second parts 210 and 220 is preferably carried out in a controlled and accelerated manner by equipping, for example, the stamping tool with a cooling system of the pulsed air type or any other system capable of reaching cooling rates ranging from the order of 30 °C/minute to 100 °C/minute.

The mold areas defining the limits of the molding cavity can also be temperature-regulated in a specific manner in order to avoid burr or material flash phenomena at the joint plane of the fixed and moving parts.

The acoustic component 120 is then demolded by moving the second part 220 in a direction opposite to that of the first part 210 and by opening the side clamps in order to release the acoustic component as illustrated in FIG. 4.

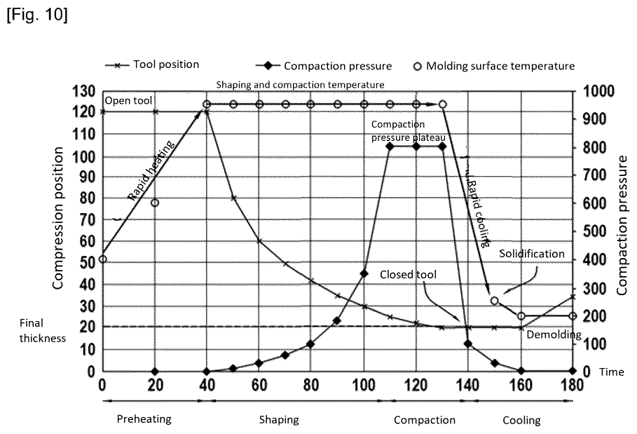

FIG. 10 is a summary graph of the steps implemented in the method of the invention. This graph shows the evolution of the temperature, pressure and position parameters of the stamping tool during the steps of the method of the invention.

Still in accordance with the invention, the shaping and compacting of the thermoplastic material preform are carried out over a total duration D_{MEF}+D_{COMP} less than a reference duration corresponding to a fraction of the degradation duration of the thermoplastic material of the preform at the first temperature. Indeed, given that in the method of the invention the thermoplastic material of the preform is exposed to high temperatures during the shaping and compacting thereof, there is a risk of degradation of the thermoplastic material during these steps of the method. The degradation durations of a thermoplastic material are generally defined in the data of the material supplier. If necessary, the degradation duration of a thermoplastic material can be measured by carrying out mechanical and/or physicochemical tests on samples exposed to the intended treatment temperature over specific durations.

A reference duration is thus defined corresponding to a fraction or a percentage of the degradation duration of the thermoplastic material at the treatment temperature considered for the shaping and compacting steps.

According to one aspect of the method of the invention, the reference duration D_{REF} corresponds to 80% of the degradation duration of the material. Thus, the cumulative duration D_{MEF} of the shaping step and the duration D_{COMP} of the compacting step must not exceed the duration D_{REF} in order to preserve the mechanical and/or physicochemical properties of the thermoplastic material in the final acoustic component.

As a non-limiting example, the degradation time of a PEI grade at 400 °C is 10 minutes. If the treatment temperature chosen for the implementation and compaction steps is 400 °C, the reference duration D_{REF} will be set at 8 minutes. It is then verified that the cumulative durations D_{MEF} and D_{COMP} do not exceed 8 minutes.

The method described above allows to form hollow complex acoustic elements with very thin walls that can be comprised between 0.1 mm and 0.6 mm. Indeed, by maintaining the molding surfaces of the stamping tool at a temperature that is above the glass transition or melting temperature of the thermoplastic material during shaping and compaction, it facilitates the homogeneous distribution of material flows between the molding surfaces, which allows the reliable and repeatable manufacture of acoustic components.

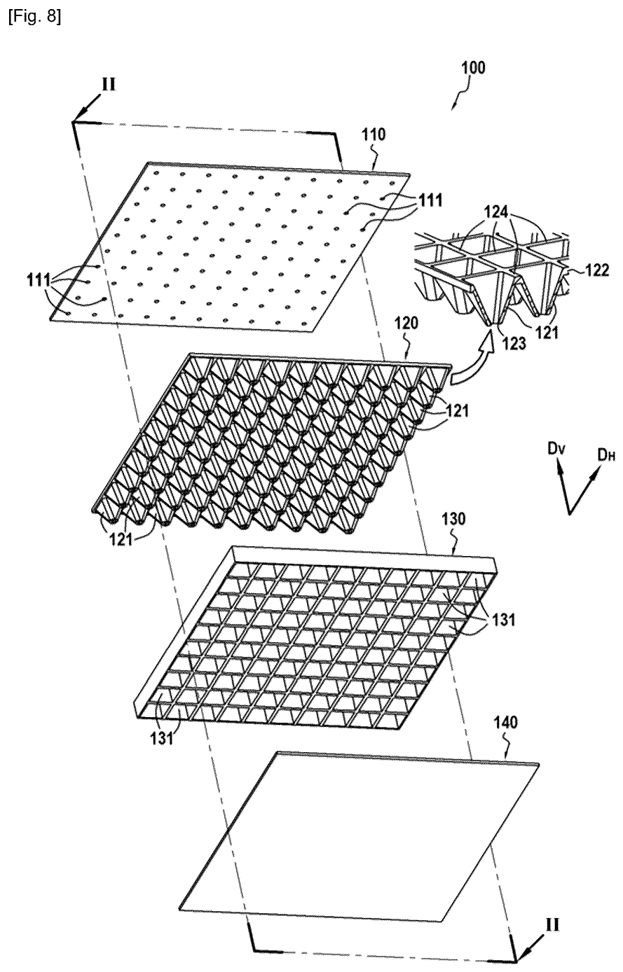

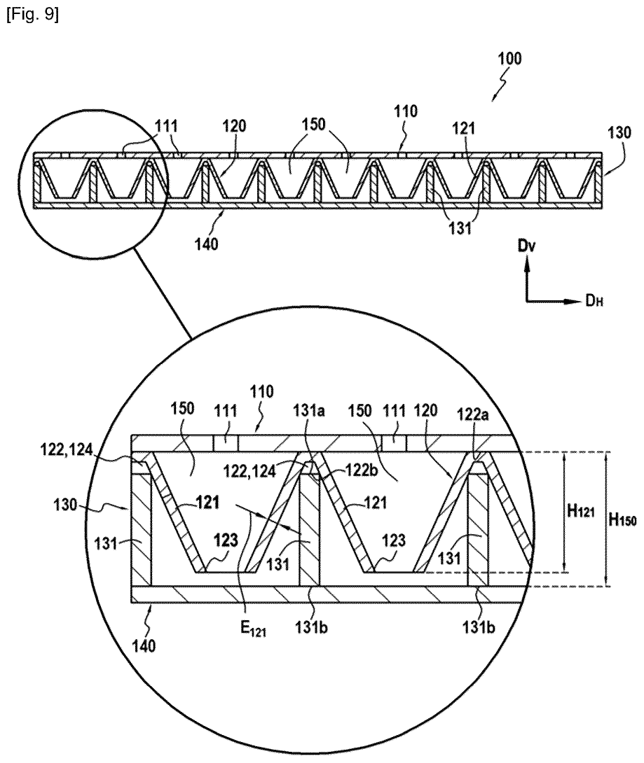

An acoustic component 120 is then obtained as illustrated in FIGS. 8 and 9 comprising a plurality of hollow complex acoustic elements 121 each having a shape gradually narrowing between a base 122 and a top 123 and a wall thickness E₁₂₁ less than 1 mm (FIG. 9). The shape of the molding cavities of the mold defines the shape of the hollow complex acoustic elements of the acoustic component. In the example described here, the molding cavities 211 have a pyramidal shape allowing to form hollow complex acoustic elements 121 of the same shape. The molding cavities and, consequently, the resulting hollow complex acoustic elements may have other shapes such as a conical, spiral, funnel or hopper shape.

The acoustic component manufactured according to the method of the invention may have a planar shape like the acoustic component 120 illustrated in FIGS. 8 and 9 or a curved shape having a single or multiple curvature. In the latter case, the curvature(s) may be produced directly during the shaping of the preform with a tool having a suitable geometry or afterwards by conformation or hot forming.

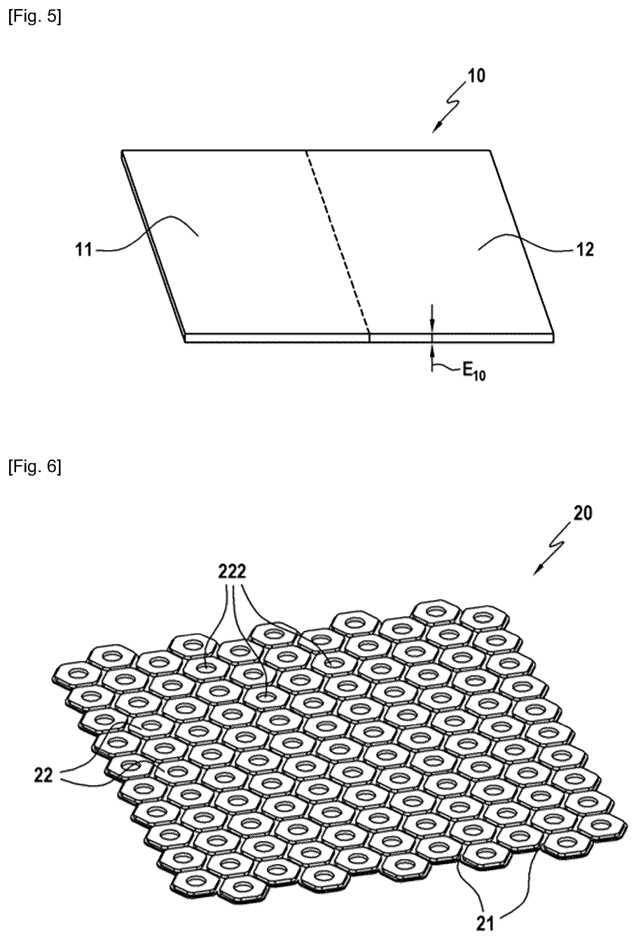

The thermoplastic material preform used to manufacture the acoustic component may have a constant thickness like the preform 10 illustrated in FIG. 5. The preform may be made in one single piece or obtained by welding several unitary films joined together like the unitary films 11 and 12 of FIG. 5 which, once welded, form a thermoplastic material preform 10 of constant thickness E₁₀. The thermoplastic material preform may be manufactured from granules of thermoplastic material by injection or any other suitable method.

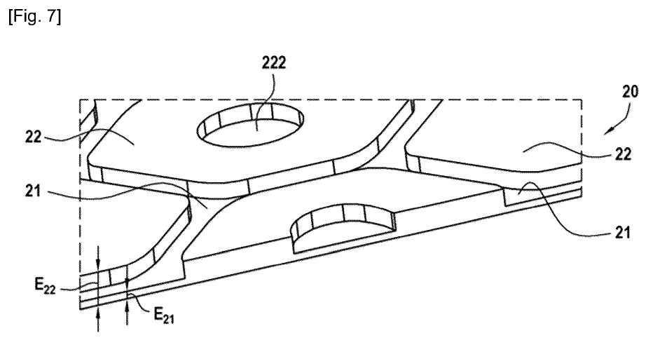

The thermoplastic material preform used to manufacture the acoustic component may also have a variable thickness like the preform 20 illustrated in FIGS. 6 and 7. More specifically, the thermoplastic material preform 20 has a plurality of excess thickness portions 22 having a thickness E₂₂ greater than the thickness E₂₁ of the connecting portions 21 of the preform 20 present between the excess thickness portions 22 (FIG. 7). The excess thickness portions 22 are present at determined locations on the preform, these locations corresponding to the locations of the cavities of the first part of the stamping tool. The excess thickness portions 22 constitute a surplus of material which, once stretched or flowed into the cavities during the shaping of the acoustic component, will allow to form hollow complex acoustic elements with a wall thickness close to that of the connecting portions 21. The volume of material present in each excess thickness portion is defined as a function of the wall thickness of each complex acoustic element to be manufactured. The excess thickness portions may have a circular, annular or hexagonal shape and be distributed uniformly over the film. In the example described here, each excess thickness portion 22 extends between connecting portions 21 and an opening or cavity 222 present in the center of the excess thickness portion. Each opening or cavity 222 is intended to be aligned with the center of the molding cavities of the mold. According to a particular characteristic, the central opening or cavity 222 forms a hole. This allows to obtain the outlet orifice of each complex acoustic element immediately after shaping. This avoids an additional machining operation. The diameter of the opening or cavity 222 is preferably greater than the diameter of the end of the teeth 221 of the counter-mold 220. By way of non-limiting example, in the case where the diameter of the end of the teeth of the counter-mold is 5 mm, the hole formed by the central opening has a diameter comprised between 6 mm and 7 mm.

Each excess thickness portion is intended to form by stretching or creep a hollow complex acoustic element 121 having a shape which gradually narrows between its base 122 and its top 123. Therefore, it goes from an initial planar surface Spl corresponding to the excess thickness portion which extends between connecting portions 21 and the central opening or cavity 222, to a larger projected surface Spr corresponding to the surface of the hollow complex acoustic element 121. The ratio between the initial planar surface Spl and the projected surface Spr defines a slenderness factor Fe which can be between 2 and 5. The principle is that of mass conservation. Thus, the initial planar surface Spl and the initial thickness E₂₂ of each excess thickness portion 22 is defined as a function of the final projected surface Spr and thickness E₁₂₁ of each hollow complex acoustic element 121 according to the following formula:

Spl×E₂₂=Spr×E₁₂₁

In the case where it is sought to produce an acoustic component of constant thickness Ec, the thickness E₂₂ of the excess thickness 22 can be determined according to the following formula:

E₂₂=(Spr/Spl)×Ec=Fe×Ec

In this case, the thickness E₂₁ of the connecting portions 21 which are not intended to be stretched or crept corresponds substantially to the final thickness of the acoustic component 120.

By way of non-limiting example, the thickness E₂₁ of the connecting portions 21 may for example be 0.5 mm while the thickness E₂₂ of the extra thickness portions 22 may be 1.6 mm.

Such a variable thickness thermoplastic film can be manufactured by calendering, machining, stacking of unit wires, injection molding, etc.

A method for manufacturing an acoustic attenuation structure according to one embodiment of the invention is now described in relation to FIGS. 8 and 9. The acoustic attenuation structure 100 here comprises an acoustic skin or plate 110, an acoustic component 120 manufactured as previously described, a plurality of partitions 131 and a closing skin or plate 140.

The closing skin 140 corresponds to a solid surface intended to reflect the sound waves entering the acoustic attenuation structure. The closing skin may be a constituent element of the acoustic attenuation structure as in the example described here or correspond to a structure of an object, for example an aircraft engine. In the latter case, the acoustic attenuation structure of the invention does not comprise a closing skin and is directly mounted on the structure of the object.

The acoustic skin 110 has the function of allowing the sound waves to be attenuated to pass inside the acoustic attenuation structure 100. For this purpose and in the example described here, the acoustic skin 110 comprises a plurality of perforations 111.

The acoustic component 120 is formed in one single piece and extends in length and width along a horizontal direction D_{H} and in height along a vertical direction D_{V}. The acoustic component comprises a plurality of hollow complex acoustic elements 121 each having a shape gradually narrowing between a base 122 and a top 123.

In the example described here, the complex acoustic elements 121 have a pyramidal shape. The base 122 of each complex acoustic element 121 is in continuous contact with the base of adjacent complex acoustic elements so as to form a continuous array of edges 124.

In the embodiment described here, the plurality of partitions 131 is made in one single piece, namely an array of ribs 130 which, once assembled with the complex acoustic multi-element panel 120, forms the partitions around the complex acoustic elements 121.

Still in the example described here, the acoustic attenuation structure 100 is produced by assembling the complex acoustic multi-element panel 120 with the plurality of partitions 131 in one single piece, the upper edge 131a of the partitions 131 being fixed, for example by gluing or welding, on the lower portion 122b of the bases 122 of the complex acoustic elements 121 (FIG. 9). The plurality of complex acoustic elements being formed in one single piece within the complex acoustic multi-element panel and the plurality of partitions also being formed in one single piece, the assembly between these two elements is greatly facilitated by the self-positioning of the complex acoustic elements with the partitions.

The closing skin 140 is fixed, for example by gluing or welding, on the lower edge 131b of the partitions 131 while the acoustic skin 110 is fixed, by gluing or welding, on the upper portion 122a of the bases 122 of the complex acoustic elements 121 corresponding to the exposed surface of the edges 124. Thus, the acoustic skin and the closing skin are each fixed on a perfectly flat support in the horizontal direction D_{H}, which allows to ensure very good sealing between the skins and the assembly of the complex acoustic multi-element panel with the plurality of partitions.

Once assembled, the attenuation structure 100 comprises a plurality of acoustic cells 150 each formed by a complex acoustic element 121 and the partitions 131 which surround it (FIG. 9). The height H₁₂₁ of the complex acoustic elements 121 is less than the height H₁₅₀ of the acoustic cells 150. More precisely, the height H₁₂₁ of the acoustic cells is comprised between 10% and 99% of the height H₁₅₀ of the acoustic cells in the vertical direction. The height H₁₂₁ may be comprised between 5 mm and 100 mm, for example 20 mm, while the base of each element 121 may be inscribed in a circle with a diameter comprised between 5 mm and 50 mm, for example 20 mm. Furthermore, thanks to the manufacturing method of the invention, the hollow complex acoustic elements 121 have a very low thickness E₁₂₁, less than 1 mm and typically comprised between 0.1 mm and 0.6 mm.

The acoustic skin, the plurality of partitions and the closing skin can be produced by injection of a thermoplastic or thermosetting material, whether filled or not, by injection-compression of a thermoplastic or thermosetting material, whether filled or not, or by injection with control of the temperature of the tool of a thermoplastic or thermosetting material, whether filled or not.

The plurality of partitions, the acoustic and closing skins as well as the assemblies joining in one single piece the plurality of partitions and the complex acoustic multi-element panel or the plurality of partitions and one of the skins can also be produced by injection of a thermoplastic or thermosetting material, whether filled or not.

1. A method for manufacturing an acoustic component comprising a plurality of hollow complex acoustic elements each having a shape gradually narrowing between a base and a top, the hollow complex acoustic elements being connected to each other by one or more adjacent edges, the method comprising:
positioning a thermoplastic material preform between first and second parts of a stamping tool, the first part having a molding surface including a plurality of cavities having a shape corresponding to the shape of the hollow complex acoustic elements of the acoustic component to be manufactured, the second part having a molding surface comprising a plurality of protuberances having a shape complementary to the cavities, the first and second parts of the stamping tool being heated to a first temperature that is above the glass transition or melting temperature of the preform,
shaping the thermoplastic material preform by bringing together the first and second parts of the stamping tool at a determined rate so as to gradually compress the preform between the molding surfaces of said first and second parts until reaching a closed position of the stamping tool, a compaction pressure exerted between first and second parts of the stamping tool being progressively increased up to a compaction pressure value, the first and second parts of the stamping tool being maintained at the first temperature during the shaping of the preform, the stamping tool being associated with a press for applying a compaction pressure between the first and second parts of the tool,
compacting the shaped preform in the stamping tool in the closed position, the compacting being carried out at the compaction pressure value and over a determined compaction duration, the first and second parts of the stamping tool being maintained at the first temperature during the compaction of the preform,
cooling the molding surfaces of the first and second parts of the stamping tool to a second temperature of less than or equal to the solidification temperature of the thermoplastic material,
demolding the acoustic component comprising a plurality of hollow complex acoustic elements,
wherein the shaping and compacting of the thermoplastic material preform are carried out over a total duration less than a reference duration corresponding to a fraction of the duration of degradation of the thermoplastic material of the preform at the first temperature.

2. The method according to claim 1, wherein the reference duration corresponds to 80% of the degradation duration of the thermoplastic material of the preform at the first temperature.

3. The method according to claim 1, wherein the thermoplastic preform is preheated before being shaped, the preform being preheated to a third temperature of less than the softening temperature of the thermoplastic material, the preheating of the preform being carried out by heating panels or by radiation by maintaining the preform between the first and second parts of the stamping tool for a determined duration before the shaping of said preform.

4. The method according to claim 1, wherein, when cooling the molding surfaces of the first and second parts of the stamping tool, the pressure is gradually decreased from the compaction pressure value to atmospheric pressure, the decrease in pressure being controlled to reach atmospheric pressure when the molding surfaces of the first and second parts of the stamping tool have reached the solidification temperature of the thermoplastic material.

5. The method according to claim 1, wherein the thermoplastic material preform has a plurality of excess thickness portions present at determined locations and spaced from each other by connecting portions having a thickness less than the thickness of the excess thickness portions, said locations corresponding to the locations of the cavities of the molding surface of the first part of the stamping tool.

6. The method according to claim 5, wherein the volume of material present in each excess thickness portion is defined as a function of the wall thickness of each complex acoustic element to be manufactured.

7. The method according to claim 6, wherein the surface and the thickness of each excess thickness portion is defined as a function of a projected surface and a thickness of each hollow complex acoustic element.

8. The method according to claim 5, wherein each excess thickness portion extends between the connecting portions and an opening or cavity present in the center of the excess thickness portion.

9. The method according to claim 8, wherein the opening or cavity forms a hole.

10. The method according to claim 1, wherein the cavities of the molding surface of the first part of the stamping tool have a pyramidal, conical, spiral, funnel or hopper shape.

11. The method according to claim 1, wherein the complex acoustic elements of the acoustic component have a wall thickness comprised between 0.1 mm and 0.6 mm.

12. A method for manufacturing an acoustic attenuation structure comprising:
producing an acoustic component according to the method as defined in claim 1,
producing a complex acoustic multi-element panel comprising the acoustic component and a plurality of partitions forming acoustic cavities, each complex acoustic element of the acoustic component being housed in an acoustic cavity so as to form an acoustic cell,
assembling a face of the complex acoustic multi-element panel with an assembly face of an acoustic skin.

13. A method according to claim 12, wherein the acoustic attenuation structure further comprises a closing skin covering the horizontal face of the complex acoustic multi-element panel opposite the horizontal face covered by the acoustic skin, the method comprising assembling the workpiece joining the complex acoustic multi-element panel and the plurality of partitions with the closing skin.
